(19) United States
(12) Patent Application Publication
(10) Pub. No.: US 2006/0204301 A1
(43) Pub. Date: Sep. 14, 2006

(54) Image forming apparatus

(75) Inventor: Takeshi Ishii, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/359,132

(22) Filed: Feb. 21, 2006

(30) Foreign Application Priority Data
Feb. 23, 2005 (JP) 2005-46616

(51) Int. Cl. G03G 15/00

(52) U.S. Cl. 399/401

(57) ABSTRACT

Disclosed is an image forming apparatus (1) in which a sheet (P) is fed through a conveyance passage from one wall (2a) to the other wall (2b) of a box-shaped housing (2), and the sheet (P) reversed in a reversing passage (28) near the other wall (2b) is discharged in a discharge section of a top wall (2c), and the other wall (2b) near which the reversing passage (28) is provided includes an upper portion projecting outward in the top wall (2c) and a lower portion receding inward in a bottom wall (2d) so that an area of the bottom wall (2d) is smaller than that of the top wall (2c). Therefore, a space for an installation can be reduced when the image forming apparatus (1) is disposed on a desk (40) and the like.

### BACKGROUND OF THE INVENTION

1. Field of the Invention

The present invention relates to an image forming apparatus, such as a printer.

2. Description of the Related Art

Conventionally, there has been known an image forming apparatus in which a toner image on a peripheral surface of a photoconductive drum is transferred and fixed on a sheet during a process of feeding the sheet through a conveyance passage from a front wall (one wall) to a rear wall (the other wall) of a housing of the image forming apparatus, and the sheet reversed in a reversing passage connected to the conveyance passage is discharged in a discharge section in a top wall of the housing of the image forming apparatus, as disclosed in Japanese Unexamined Patent Publication No. Hei. 8-240945.

The housing of the image forming apparatus as above is formed into a box-shape, and the rear wall of the housing near which the reversing passage is provided is generally formed in a vertical direction. Accordingly, it is necessary to dispose the vertical rear wall in such a rearward position as to provide the reversing passage with a space for assuring smooth conveyance.

However, the bottom area of the housing is the same as the top area of the housing. Consequently, in the case of installing the image forming apparatus on a desk and the like, a large space is needed for its installation. Further, the image forming apparatus is often installed in the state that the rear wall of the housing faces a wall of a room. In the case where a plug of an electronic power supply cable or an interface cable, such as a printer cable, is connected to a cable connection port provided in the rear wall, a space for accommodating the plug and the cable is required between the rear wall of the housing and the room wall, which consequently causes the installation to require a larger space. Further, in the case of providing an outflow opening in the rear wall, it is necessary to dispose the image forming apparatus to provide a sufficient distance from the room wall to keep the outflow opening from being blocked off. Accordingly, it also causes the installation to require larger space.

### SUMMARY OF THE INVENTION

In view of the above problem, it is an object of the present invention to provide an image forming apparatus which can be installed closer to a wall of a room with a reduced installation area.

In order to solve the problem, according to an aspect of the invention, in an image forming apparatus where a toner image on a peripheral surface of a photoconductive drum is transferred and fixed on a sheet in a process of feeding the sheet through a conveyance passage from one wall to the other wall, and the sheet reversed in a reversing passage connected to the conveyance passage is discharged in a discharge section in a top wall of the image forming apparatus, the other wall near which the reversing passage is provided includes an upper portion projecting outward and a lower portion receding inward.

With this construction, the other wall near which the reversing passage is provided includes the upper portion projecting outward and the lower portion receding inward. Thus, a bottom area of the housing is smaller than a top area of the housing. This can provide a reduced installation space for installation of an image forming apparatus on a desk or the like.

### BRIEF DESCRIPTION OF THE DRAWINGS

FIG. 1 is a perspective view showing a printer according to an embodiment of the present invention.

FIG. 2 is a cross sectional view from side showing a schematic configuration of the printer.

FIGS. 3A to 3D show the printer, wherein FIG. 3A is an explanatory view showing a rear of the printer, FIG. 3B is a cross sectional view from side showing a cable connection port, FIG. 3C is a cross sectional view from side showing an electrical power switch, and 3D is a cross sectional view from side showing an outflow opening.

### DETAILED DESCRIPTION OF THE PREFERRED EMBODIMENTS

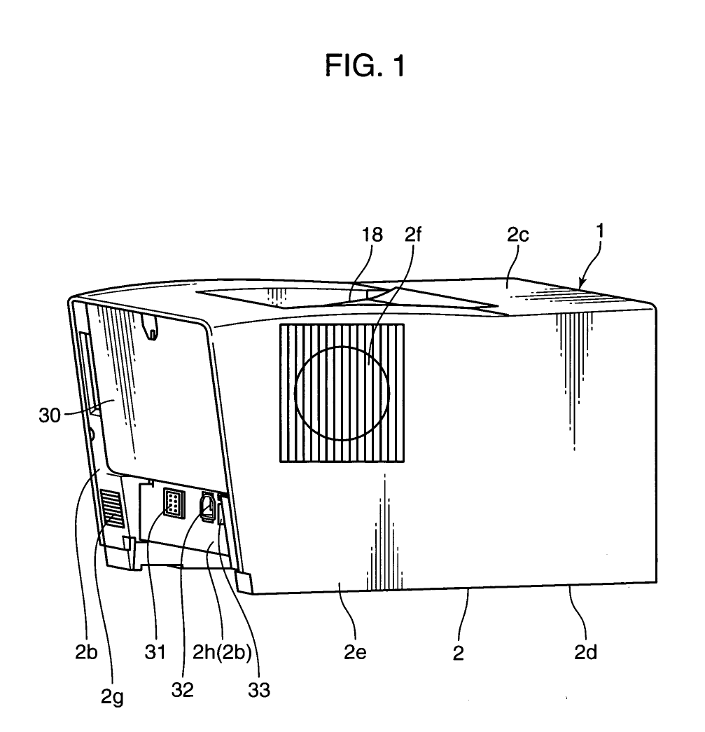

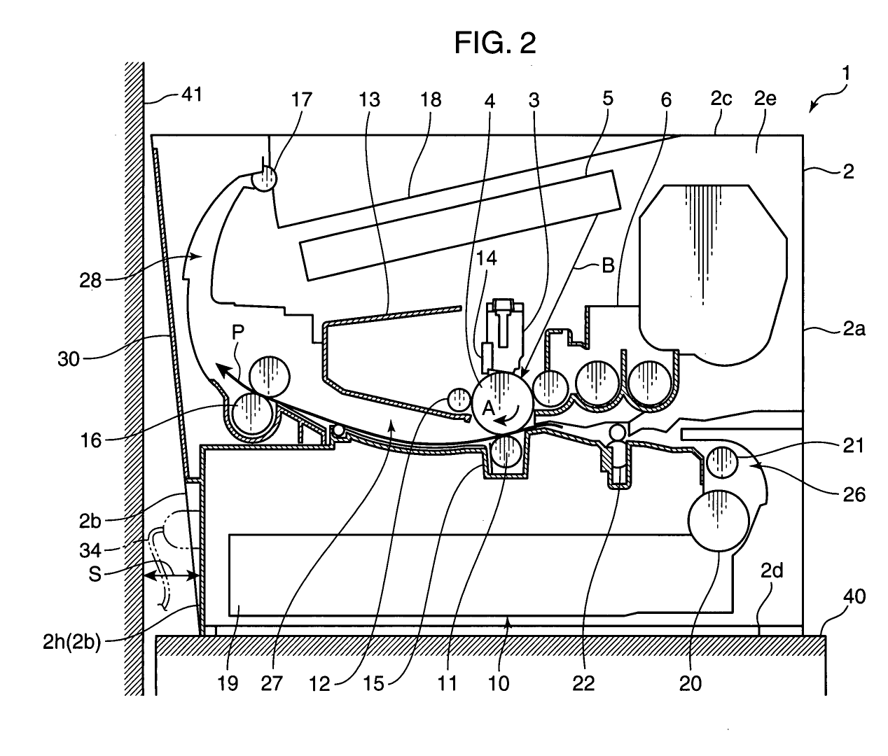

FIG. 1 is a perspective view showing a printer according to an embodiment of the present invention, which is an image forming apparatuses. FIG. 2 is a cross sectional view from side, showing a schematic configuration of the printer.

In a box-shaped housing 2 of the printer 1, a peripheral surface of a photoconductive drum 4 rotating in a direction A in FIG. 2 is uniformly charged by a charging device 3, a laser beam B in accordance with an image data is irradiated from an exposure unit 5, such as a laser scanning unit, and an electrostatic latent image is formed on the peripheral surface of the photosensitive drum 4. Then, toner particles are supplied on the electrostatic latent image formed on the peripheral surface of the photoconductive drum 4 from a developing section 6 so as to form a toner image on the peripheral surface of the photoconductive drum 4.

A sheet P is fed to the photoconductive drum 4 from a sheet supplying mechanism 10. A toner image on the peripheral surface of the photoconductive drum 4 is transferred onto the sheet P by a transferring device including a transferring roller 11. A cleaning device 13 including a cleaning roller 12 removes residual toner particles from the peripheral surface of the photoconductive drum 4. A neutralization device 14 removes residual electrical charge remaining after toner particles are removed.

A sheet P separated from the photoconductive drum 4 by a separating device 15 is fed to a fixing device including a pair of fixing rollers 16 which is adapted for fixing the toner image onto the sheet P, and then, discharged by a discharging roller 17 to a discharge section 18.

The sheet supplying mechanism 10 is detachably mounted on the housing 2, and provided with a sheet supplying cassette 19 which can accommodate a number of sheets P in a stacked state. The sheet supplying cassette 19 includes a picking-up roller 20 for picking up the accommodated sheet P and a sheet supplying roller 21 for feeding the sheet P picked up by the picking-up roller 20 to a conveyance passage one by one. A pair of registration rollers 22 for regulating the conveying of the sheet P are disposed on an upstream (a right side of the FIG. 2) of the photoconductive drum 4 in the conveyance passage.

The conveyance passage includes a first conveyance passage 26 for feeding the sheet P from the sheet supplying cassette 19 to the photoconductive drum 4, a second conveyance passage 27 for feeding the sheet P from the photoconductive drum 4 to the pair of fixing rollers 16, and a third conveyance passage (a reversing passage) 28 for feeding the sheet P from the pair of fixing rollers 16 to the pair of discharging rollers 17.

The first conveyance passage 26 is arranged in such a manner that it extends upward substantially vertically in a relatively right side of the housing 2 in FIG. 2, and curves toward a left side of the housing 2 at a middle height of the housing 2 to extend horizontally up to the photoconductive drum 4.

The third conveyance passage 28 is arranged in such a manner that it extends upward substantially vertically from the middle height of the housing 2 in a relatively left side of the housing 2, that is, opposite to the first conveyance passage 26.

The second conveyance passage 27 extends substantially horizontally from the transferring roller 11 to the fixing roller 16 in the middle height of the housing 2 in order to connect the first conveyance passage 26 to the third conveyance passage 28.

Next, description is made with respect to a sheet feeding when the printer 1 is operated.

The sheet P is picked up by the picking-up roller 20 from the sheet supplying cassette 19 of the sheet supplying mechanism 10. The picked up sheet P is fed by the sheet supplying roller 21 to the first conveyance passage 26 one by one. Then the conveying of the sheet P fed to the conveyance passage 26 is regulated in the pair of registration rollers 22.

After the toner image is formed on the peripheral surface of the photoconductive drum 4, the sheet P is released by the pair of the resist rollers 22 to the photoconductive drum 4. The toner image formed on the photoconductive drum 4 is transferred on a transferable surface of the sheet P by the transferring roller 11 disposed opposite to the photoconductive drum 4.

Then, the sheet P separated from the photoconductive drum 4 by the separating device 15 is fed to the pair of fixing rollers 16 through the second conveyance passage 27.

The toner image is fixed on the sheet P by the pair of fixing rollers 16. Then, the sheet P is discharged by the discharging roller 17 to the discharge section 18 without further processing or after being performed with both-side copying by using an unillustrated switchback section.

The housing 2 has a box-shape formed by a front wall (one wall) 2a, a rear wall (the other wall) 2b, a top wall 2c, a bottom wall 2d, and both side walls 2e. The rear wall 2b is often set on a desk 40 facing a room wall 41. With this arrangement, the sheet P can be supplied to the sheet supplying cassette 19 by pulling the sheet supplying cassette 19 out from an opening in the front wall 2a.

The top wall 2c is provided with the discharge section 18 where the sheet P is discharged. One of the side walls 2e is provided with an outflow opening 2f. The outflow opening 2f is provided near the pair of fixing rollers 16, and cools the pair of fixing rollers 16.

The rear wall 2b includes an upper portion projecting outward near the top wall 2c and a lower portion receding inward near the bottom wall 2d. The rear wall 2b includes an openable door 30 inclined along the rear wall 2b for a possible jam in the third conveyance passage.

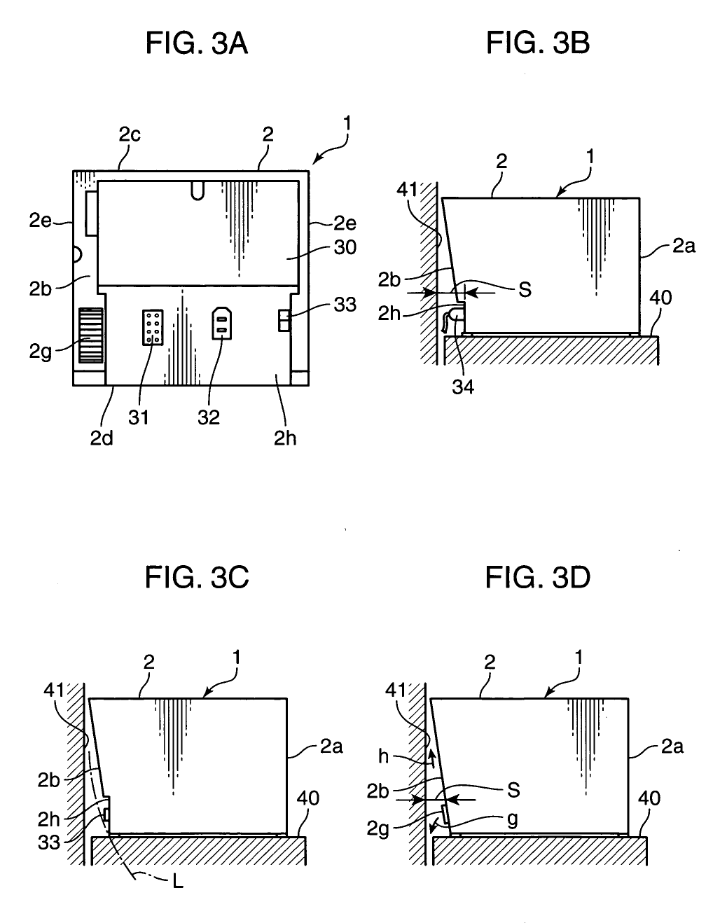

As shown in FIG. 3A, the rear wall 2b is provided with an outflow opening 2g in one side of a lower part thereof (in the left side in FIG. 3A). The outflow opening 2g is provided in the vicinity of a high voltage electric power supply board or a control board so as to cool these boards. The outflow opening 2g and the outflow opening 2f are connected with each other with a duct (not shown). Thus, even if the one of them is blocked off by a wall 41 of a room which the printer 1 is placed in and the like, the other one is in an outside open space.

The rear wall 2b includes a vertical wall 2h, as a part thereof, which recedes inwardly from the rear wall 2b and is formed in a center of the lower part or the rear wall 2b. The vertical wall 2h is provided with a cable connection port 31 for a plug of an interface cable, a cable connection port 32 for a plug of the electric power supply cable, and an electric power switch 33.

With the printer 1 configured as above, in the housing 2, the rear wall 2b near which the third conveyance passage 28 is provided includes the upper portion projecting outward in the top wall 2c and the bottom portion receding inward in the bottom wall 2d. Accordingly, the area of the bottom wall 2d is smaller than that of the top wall 2c, so that the space for installing the printer 1 can be reduced in the case of installing the printer 1 on the desk 40 and so on.

The third conveyance passage 28 (the reversing passage) is disposed in a space projecting outward near the top wall 2c in the inclined rear wall 2b so that the space for the third conveyance passage 28 (the reversing passage) can be assured taking advantage of an inclination of the rear wall 2b, thereby ensuring the conveying performance of the third conveyance passage 28 (the reversing passage).

Further, the vertical wall 2h which is a part of the inclined rear wall 2b is provided with the cable connection ports 31 and 32, and the electrical power switch 33. Even if the housing 2 is so disposed that the rear wall 2b faces the room wall 41, the rear end of the top wall 2c can be disposed within a tiny distance from the room wall 41. This is because a space S for a projection 34 of a plug and a cable of the cable connecting ports 31 and 32 is assured between the vertical wall 2h of the inclined rear wall 2b and the room wall 41, as shown in FIG. 3B. Therefore, it is not necessary to dispose the printer 1 so as to provide the space for the projection 34 of the plug and the cable of the cable connecting ports 31 and 32. Accordingly, the installation space can be reduced.

Still further, in the case where the electrical power switch 33 is turned on or off by inserting an hand in an invisible gap from the front wall 2a, a user is not required to bow his/her body and stretch out an arm, since the inclined rear wall 2b is so shaped to extend along a locus L along which the arm swings. Thus, the electrical power switch 33 can be operated only by an arm.

Further, the outflow opening 2g is formed in the inclined rear wall 2b. In the case where the housing 2 is so set that the rear wall 2b faces the room wall 41 and the rear end of the top wall 2c comes to a very near position to the room wall 41, because the space S is assured between the inclined rear wall 2b and the room wall 41, as shown in FIG. 3D, it is not necessary to dispose the printer 1 to provide a sufficient distance from the room wall 41 to keep the outflow opening 2g from being blocked off. Accordingly, the space for installation can be reduced.

In the case of forming an outflow opening facing a room wall directly in the conventional way, discharged air from the outflow opening is often flown upward (see an arrow h in FIG. 3D). Thus, the sheet P and the like disposed on a surface of the top wall 2c of the housing 2 may be blown off by the discharged air and disperses unexpectedly. However, if the outflow opening 2g is formed on the inclined rear wall 2b, the discharged air is blown downward (see an arrow g in FIG. 3D). Therefore, there is not the likelihood that the sheet P is blown off and dispersed unexpectedly by the air.

Further, in the case where the rear wall 2b of the housing 2 is installed without facing the room wall 41, if an outflow opening is formed in a vertical rear wall as the conventional way, the discharged air is blown out from the outflow opening in a horizontal direction to consequently hit directly the face or other portion of a person who sits close to the printer. However, the outflow opening 2g is formed in the inclined rear wall 2b. Accordingly, the discharged air (see the arrow g in FIG. 3) is blown out downward so that the discharged air will not hit directly a person who sits close to the printer.

In the foregoing embodiment, the printer 1 is raised as an example. The printer 1 is shaped into a box as a usual shape. Accordingly, the advantageous effects can be seen in compact-type or small-type printers to be placed on a desk. However, it is needless to say that the present invention may be applied to other image forming apparatuses such as a copying machine, a facsimile machine, or a composite machine.

This application is based on patent application No. 2005-46616 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. An image forming apparatus in which a toner image is transferred onto a sheet from a photoconductive drum and fixed in a process of conveying the sheet in a conveyance passage from one wall to the other wall of a box-shaped housing, and the sheet is reversed in a reversing passage near the other wall and connected to the conveyance passage, and is discharged to a discharge section at an upper wall of the housing,
wherein the other wall near which the reversing passage is provided has an upper portion projecting outward and a lower portion receding inward.

2. An image forming apparatus according to claim 1, wherein the reversing passage is arranged in the vicinity of the upper portion of the other wall.

3. An image forming apparatus according to claim 1, wherein a cable connection port and an electric power switch are provided in the other wall.

4. An image forming apparatus according to claim 1, wherein an outflow opening is formed in the other wall.

5. An image forming apparatus according to claim 1, wherein the image forming apparatus is a printer.
